(19) United States
(12) Patent Application Publication
(10) Pub. No.: US 2008/0126422 A1
(43) Pub. Date: May 29, 2008

(54) Data transmitting and receiving system and method

(75) Inventor: Chi-Tong Lai, Taoyuan County (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/889,568

(22) Filed: Aug. 14, 2007

(30) Foreign Application Priority Data
Nov. 29, 2006 (TW) 095144219

(51) Int. Cl. G06F 17/30; G06F 15/16

(52) U.S. Cl. 707/104.1; 709/219; 707/E17.005

(57) ABSTRACT

The invention discloses a data transmitting and receiving system comprising a first service provider, a second service provider, and an electronic device. The first service provider provides a plurality of media information and a plurality of tags, where each of the media information corresponds to one of the tags respectively. The second service provider provides a plurality of image files, wherein each of the image files records one of the tags respectively. The electronic device receives one of the image files from the second service provider, translates the tag from the image file, and downloads the media information corresponding to the tag.

### BACKGROUND OF THE INVENTION

1. Field of the Invention

The invention relates to a data transmitting and receiving system and method, and more particularly, to a data transmitting and receiving system and method for providing imaged tags.

2. Description of the Prior Art

Controversial web 2.0 unveils the new era of the web. In the world of web 2.0, a tag is a critical component. A tag is a keyword or term associated with or assigned to a piece of media information such as an article, an image, a video, an audio, an animation, even an online resource such as a computer file, a web page, an internet bookmark, and the like.

However, tags usually lack precise definitions or semantic distinction. For example, the tag “apple” might refer to the fruit, Apple, Inc., universal gravitation, or something else. Additionally, the selection of “tag” is highly individualistic. Different people may use drastically different terms to describe the same concept. Moreover, different websites might define their tags differently, either. Therefore, without a given subject, it is difficult for users to realize the real meaning of tags, and users are frequently misled to media information they do not take interest in.

More and more electronic devices have the capability of playing miscellaneous media information. Electronic devices with communication capability can download media information or internet resources through a communication network, so as to provide users with abundant information they need. Nevertheless, the electronic devices are usually limited in size to achieve portability, and therefore their input interfaces are usually too small to input text strings or symbol strings, which makes the users unable to acquire media information or internet resources of interest smoothly using a tag-based method.

Accordingly, one scope of the invention is to provide a data transmitting and receiving system and method to solve the aforesaid problem.

### SUMMARY OF THE INVENTION

A scope of the invention is to provide a data transmitting and receiving system and method for providing imaged tags so that a user can easily comprehend the media information associated with the tag by simply looking at the image. Furthermore, when a user wants to share certain media information with a friend, he or she has to merely transmit the image file which records the corresponding tag to the friend's electronic device, instead of inputting a quantity of text strings or symbol strings associated with the tag.

According to an embodiment of the invention, the data transmitting and receiving system comprises a first service provider a second service provider, and an electronic device. The first service provider provides a plurality of media information and a plurality of tags wherein each of the media information corresponds to one of the tags. The second service provider provides a plurality of image files which each therein records one of the tags respectively. The electronic device is capable of receiving one of the image files from the second service provider, parsing the received image file to obtain the tag, and downloading the media information corresponding to the obtained tag from the first service provider.

Accordingly, the data transmitting and receiving system and method according to the invention can provide imaged tags so that a user can easily comprehend the media information associated with the tag simply by looking at the image. Furthermore, when a user wants to share certain media information with a friend, he or she has to merely transmit the image which records the corresponding tag to the friend's electronic device, instead of inputting a quantity of text strings or symbol strings associated with the tag.

The advantage and spirit of the invention may be understood by the following recitations together with the appended drawings.

### BRIEF DESCRIPTION OF THE APPENDED DRAWINGS

FIG. 1 shows a functional block diagram of the data transmitting and receiving system according to an embodiment of the invention.

FIG. 2 shows a functional block diagram of a second service provider according to an embodiment of the invention.

FIG. 3 shows a flow chart of the data transmitting and receiving method according to an embodiment of the invention.

### DETAILED DESCRIPTION OF THE INVENTION

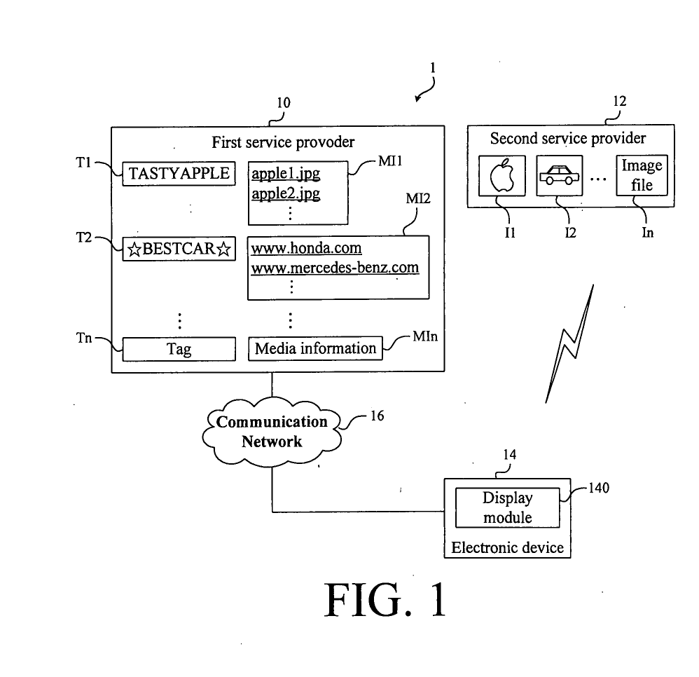

Please refer to FIG. 1. FIG. 1 shows a functional block diagram of the data transmitting and receiving system according to an embodiment of the invention. The data transmitting and receiving system 1 includes a first service provider 10, a second service provider 12, and an electronic device 14. In the embodiment, the first service provider 10 and the second service provider 12 can be web servers.

As shown in FIG. 1, the first service provider 10 provides a plurality of media information MI1-MIn and a plurality of tags T1-Tn wherein each of the media information MI1-MIn corresponds to one of the tags T1-Tn, wherein n is a natural number. The media information MI1-MIn may be in the forms of an article, an image, a video, an audio, an animation, or the like. In addition, the media information MI1-MIn may further include the forms of a computer file, a web page, an internet bookmark, or the like. In real applications, the media information MI1-MIn may comply with a Microsoft Media Service (MMS) protocol, a real-time streaming protocol (RTSP), a hypertext transfer protocol (HTTP), a progressive networks multimedia (PNM) protocol, a file transfer protocol (FTP), or the like. The tags T1-Tn can be text strings, symbol strings, or text/symbol strings, for associating or classifying the media information MI1-MIn.

As shown in FIG. 1, the tag T1 is represented by a text string “TASTY APPLE”, and its corresponding media information MI1 includes a plurality of image links (i.e. apple1.jpg, apple2.jpg, etc.). The tag T2 is represented by a text/symbol string “ [symbol] BEST CAR [symbol] and its corresponding media information MI2 includes a plurality of website links (i.e. www.honda.com, www.mercedes-benz.com, etc.). The others are reasoned by analogy.

The second service provider 12 provides a plurality of image files I1-In, which each therein records one of the tags T1-Tn respectively. The tags T1-Tn are, preferably but not limited to, recorded in exchangeable image files (EXIFs) of the image files I1-In. It is noticeable that the image files I1-In are made according to the corresponding media information MI1-MIn of the tags T1-Tn so that users can easily comprehend the media information MI1-MIn corresponding to the tag T1-Tn by seeing the image files I1-In.

As shown in FIG. 1, when a user sees image files I1, he or she can easily understand that the media information MI1 that associated with the tag T1 is related to an apple. When a user sees image files 12, he or she can easily understand that the media information MI2 that associated with the tag T2 is related to a car. The others are reasoned by analogy.

The electronic device 14 is capable of receiving the image files I1-In from the second service provider 12, parsing the received image files I1-In to obtain the tags T1-Tn, and downloading the media information MI1-MIn corresponding to the obtained tags T1-Tn from the first service provider 10. The electronic device 14 further includes a display module 140 and/or an audio module (not shown in FIG. 1) for displaying the image files I1-In received from the second service provider 12 and the media information MI1-MIn downloaded from the first service provider 10. The electronic device 14 can be a digital photo frame, a digital television receiver, a tablet PC, an ultra mobile PC, various portable media players, a personal digital assistant, a mobile communication apparatus, or the like.

In the embodiment, the electronic device 14 can download the media information from the first service provider 10 through a communication network 16. The communication network 16 can be a local area network, an intranet, an internet, a radio telecommunication network, a public switched telephone network, or the like. In real applications, a user A can transmit the image files I1-In from the second service provider 12 to a portable apparatus (not shown in FIG. 1) of a user B such as a mobile communication apparatus, a personal digital assistant, various portable media players, or the like. Then, the user B can transmit the image files of interest from the portable apparatus to the electronic device 14. After that, the user B can operate the electronic device 14 to parse the transmitted image files to obtain the tags, and to download the media information corresponding to the obtained tags from the first service provider 10. The portable apparatus and the electronic device 14 can be the same electronic apparatus (not shown in FIG. 1). That is, the electronic apparatus can both act as the portable apparatus and the electronic device 14. Accordingly, user B can omit the step of “transmitting the image file of interest from the portable apparatus to the electronic device 14” and can directly operate the electronic apparatus to parse the received image file to obtain the tag, and subsequently download the media information corresponding to the obtained tag from the first service provider 10. Thereby, the user B can enjoy the media information MI1-MIn shared by the user A via the electronic apparatus.

According to an embodiment of the invention, the service provider 10 and the second service provider 12 may be the same service provider. In other words, the tags T1-Tn, the media information MI1-MIn and the image files I1-In can be provided by one service provider.

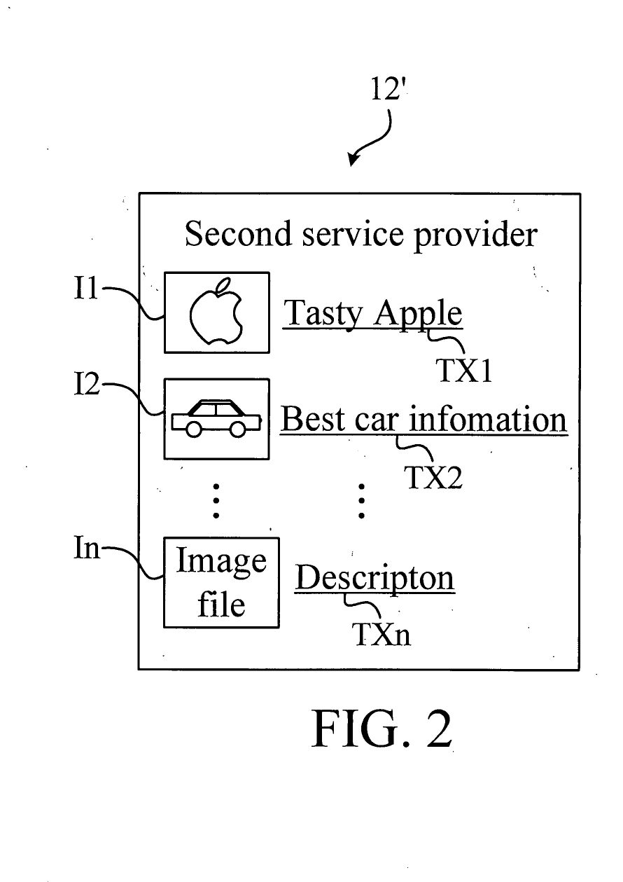

Please refer to FIG. 2. FIG. 2 shows a functional block diagram of a second service provider 12′ according to an embodiment of the invention. The primary difference between the second service provider 12′ and the second service provider 12 is that the second service provider 12′ further provides a plurality of text strings TX1-TXn which each corresponds to one of the image files I1-In. The text strings TX1-TXn are used for further describing the first service provider 10, the media information MI1-MIn, the tags T1-Tn, the image files I1-In, or any other related content such as the top 10 downloaded, user comments, or the like. The operation architecture of the service provider 12′ shown in FIG. 2 is substantially identical to the second service provider 12 shown in FIG. 1 and will not be described here in details again.

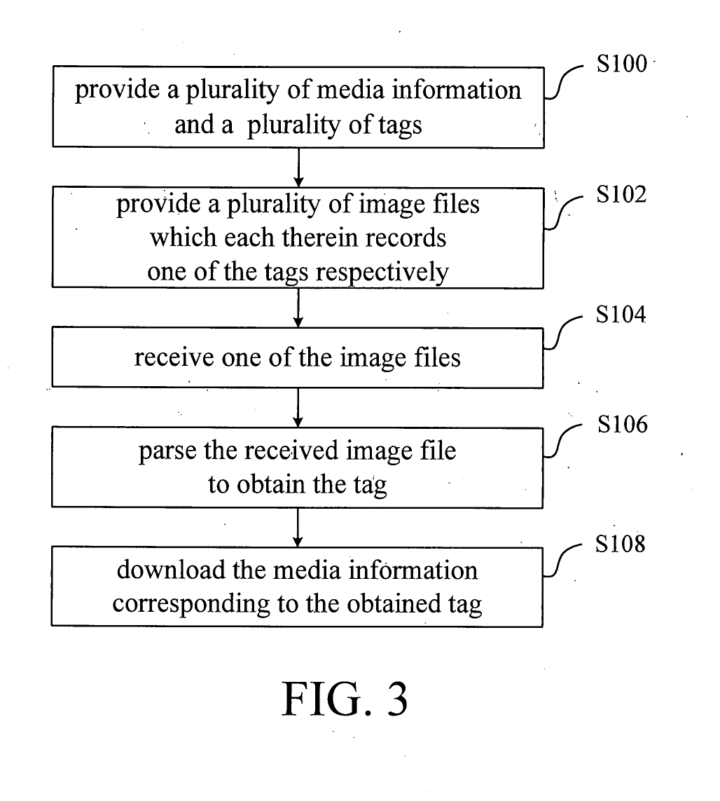

Please refer to FIG. 3 along with FIG. 1. FIG. 3 shows a flow chart of the data transmitting and receiving method according to an embodiment of the invention. As shown in FIG. 3, the method firstly performs step S100 to provide a plurality of media information MI1-MIn and a plurality of tags T1-Tn where each of the media information MI1-MIn corresponds to one of the tags T1-Tn. Then, the method performs step S102 to provide a plurality of image files I1-In, which each therein records one of the tags T1-Tn respectively. Afterwards, the method performs step S104 to receive one of the image files I1-In. Next, the method performs S106 to parse the received image file to obtain the tag. Finally, the method performs S108 to download the media information corresponding to the obtained tag.

In comparison with the prior art, the data transmitting and receiving system and method provide imaged tags so that a user can simply see the image and easily comprehends the media information associated with the tags. Furthermore, when a user wants to share certain media information with a friend, he or she has to only transmit the image which records the corresponding tag to the friend's electronic device, instead of inputting a quantity of text strings or symbol strings associated with the tag. Thereby, tags can be more extensively applicable and more popular in web 2.0 applications, and are more convenient for users as well.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data transmitting and receiving system comprising:
a first service provider for providing a plurality of media information and a plurality of tags, each of the media information corresponding to one of the tags;
a second service provider for providing a plurality of image files which each therein records one of the tags respectively; and
an electronic device for receiving one of the image files from the second service provider, parsing the received image file to obtain the tag, and downloading the media information corresponding to the obtained tag from the first service provider.

2. The data transmitting and receiving system of claim 1, wherein the first service provider and the second service provider are the same service provider.

3. The data transmitting and receiving system of claim 1, wherein the tag is recorded in an exchangeable image file (EXIF) of the image file.

4. The data transmitting and receiving system of claim 1, wherein the tag is a first text string, a symbol string, or a text/symbol string.

5. The data transmitting and receiving system of claim 1, wherein the second service provider further provides a plurality of second text strings which each corresponds to one of the image files.

6. The data transmitting and receiving system of claim 1, wherein the media information comprises one selected from a group consisting of an article, an image, a video, an audio, and an animation.

7. The data transmitting and receiving system of claim 1, wherein the media information complies with one selected from a group consisting of a Microsoft Media Service (MMS) protocol, a real-time streaming protocol (RTSP), a hypertext transfer protocol (HTTP), a progressive networks multimedia (PNM) protocol, and a file transfer protocol (FTP).

8. The data transmitting and receiving system of claim 1, wherein the electronic device comprises a display module for displaying the image file received from the second service provider and the media information downloaded from the first service provider.

9. The data transmitting and receiving system of claim 1, wherein the electronic device downloads the media information through a communication network.

10. The data transmitting and receiving system of claim 9, wherein the communication network is one selected from a group consisting of a local area network, an intranet, an internet, a radio telecommunication network, and a public switched telephone network.

11. A data transmitting and receiving method comprising steps of:
(a) providing a plurality of media information and a plurality of tags, each of the media information corresponding to one of the tags;
(b) providing a plurality of image files which each therein records one of the tags respectively; and
(c) receiving one of the image files
(d) parsing the received image file to obtain the tag,
(e) downloading the media information corresponding to the obtained tag.

12. The data transmitting and receiving method of claim 11, wherein the tag is recorded in an exchangeable image file (EXIF) of the image file.

13. The data transmitting and receiving method of claim 11, wherein the tag is a first text string, a symbol string, or a text/symbol string.

14. The data transmitting and receiving method of claim 11, wherein the step (a) further comprises the step of providing a plurality of second text strings which each corresponds to one of the image files.

15. The data transmitting and receiving method of claim 11, wherein the media information comprises one selected from a group consisting of an article, an image, a video, an audio, and an animation.

16. The data transmitting and receiving method of claim 11, wherein the media information complies with one selected from a group consisting of a Microsoft Media Service (MMS) protocol, a real-time streaming protocol (RTSP), a hypertext transfer protocol (HTTP), a progressive networks multimedia (PNM) protocol, and a file transfer protocol (FTP).

17. The data transmitting and receiving method of claim 11, wherein the step (c) further comprises the step of displaying the received image files.

18. The data transmitting and receiving method of claim 11, wherein the step (e) further comprises the step of displaying the downloaded media information.

19. The data transmitting and receiving method of claim 11, wherein the media information is downloaded through a communication network.

20. The data transmitting and receiving method of claim 19, wherein the communication network is one selected from a group consisting of a local area network, an intranet, an internet, a radio telecommunication network, and a public switched telephone network.
